(19) United States
(12) Patent Application Publication
(10) Pub. No.: US 2005/0200805 A1
(43) Pub. Date: Sep. 15, 2005

(54) Nose pad assembly

(75) Inventor: Hiroyuki Kawabata, Fukui (JP)

Correspondence Address: BACON & THOMAS, PLLC, 625 SLATERS LANE, FOURTH FLOOR, ALEXANDRIA, VA, 22314, US

(73) Assignee: SASAMATA Company, Limited, Fukui (JP)

(21) Appl. No.: 10/911,718

(22) Filed: Aug. 5, 2004

(30) Foreign Application Priority Data
Mar. 11, 2004 (JP) 2004-069079

(51) Int. Cl. G02C 1/00

(52) U.S. Cl. 351/78

(57) ABSTRACT

A nose pad assembly includes a pad leg whose first end is fitted in an engaging hole at the front portion of an eyeglass frame and a nose pad to be mounted to a second end of the pad leg. The pad leg has, at the first end, recesses and projections extending perpendicular to the axis and arranged continuously in the axial direction, which serves as come-off prevention means. The pad leg includes an axial projection serving as rotation prevention means at the first end. When the first end is fitted into the engaging hole, the recesses and projections of the come-off prevention means and the projection of the rotation prevention means engages with the inner surface of the engaging hole, thereby preventing the pad leg from coming off and rotating. The position of the engaging hole and the angle of the pad leg can be adjusted depending on consumers.

### BACKGROUND OF THE INVENTION

1. Field of the Invention

The present invention relates to a nose pad assembly and, more particularly, to a nose pad assembly in which the nose-pad mounting position and mounting angle to the front of an eyeglass frame, etc. can be set and also the nose-pad mounting position and mounting angle can be finely adjusted.

2. Description of the Related Art

Eyeglass frames are composed of multiple components, such as a pair of lens-retaining frames, a bridge connecting the inner rims of the lens-retaining frames together, and temples closably connected to the outer rims of the lens-retaining frames with hinges.

The front portion (the bridge and the lens-retaining frames) of the eyeglass frame including the multiple components has a pair of nose pads and as such, when the eyeglass frame is put on a face, the pair of nose pads is brought into contact with the opposite sides of the nose and both the temples are retained to both ears, thereby retaining the eyeglass frame in position on the face.

Of the eyeglass frames with the foregoing structure, resin eyeglass frames are constructed such that opposite lens-retaining frames and the bridge at the front portion are integrated and nose pads are integrated with the inner rims of the lens-retaining frames with an adhesive etc.

Accordingly, the nose-pad mounting position, the interval between the nose pads, the mounting angle, etc. are set at the manufacturing stage, so that, at the time of purchase, consumers cannot set the nose-pad mounting position, the interval between the nose pads, the mounting angle, etc. depending on the size, height, etc. of their noses. This hinders all people from enjoying comfortable feeling to wear (refer to Japanese Unexamined Patent Application Publication No. 2000-292606).

### SUMMARY OF THE INVENTION

The present invention has been made to solve the above-describe problems. Accordingly, it is an object of the present invention to provide a nose pad assembly in which the nose-pad mounting position, the interval between the nose pads, the mounting angle, etc. can be set depending on the size and height of consumers' noses, etc., thus giving all people comfortable feeling to wear.

In order to achieve the above object, according to embodiments of the present invention, there is provided a nose pad assembly to be mounted to the front portion of an eyeglass frame. The nose pad assembly includes a pad leg a first end of which is fitted in an engaging hole provided in the front portion, and a nose pad to be mounted to a second end of the pad leg, in which come-off prevention means which can be brought into engagement with the inner surface of the engaging hole is provided on the surface of the first end of the pad leg.

Preferably, in the nose pad assembly according to the present invention, the come-off prevention means includes a recess, a projection, or an uneven portion, formed on the surface of the first end of the pad leg.

Preferably, in the nose pad assembly according to the present invention, the recess, the projection, and the uneven portion are long along the circumference of the pad leg.

Preferably, in the nose pad assembly according to the present invention, the pad leg includes rotation prevention means which can be brought into engagement with the inner surface of the engaging hole on the surface of the first end of the pad leg.

Preferably, in the nose pad assembly according to the present invention, the rotation prevention means includes a recess, a projection, or an uneven portion, formed on the surface of the first end of the pad leg.

Preferably, in the nose pad assembly according to the present invention, the recess, the projection, and the uneven portion are long along the axis of the pad leg.

Preferably, in the nose pad assembly according to the present invention, the pad leg has a pad-mounting portion at the second end and wherein the nose pad is mounted to the pad-mounting portion through pad-mounting means.

Preferably, in the nose pad assembly according to the present invention, the pad-mounting means includes a cored bar provided to the nose pad which is fixed to the pad-mounting portion with a screw.

Preferably, in the nose pad assembly according to the present invention, the pad-mounting means includes a groove provided to the nose pad for the pad-mounting portion to fit in.

Preferably, in the nose pad assembly according to the present invention, the pad-mounting portion has a spring force.

Preferably, in the nose pad assembly according to the present invention, the pad-mounting portion has at least one projection or recess and wherein the nose pad has a recess or a projection to be fitted to the projection or the recess at the part of the groove corresponding to the projection or the recess.

Preferably, in the nose pad assembly according to the present invention, the rigidity of the engaging portion at the front portion of the eyeglass frame and its periphery is set larger than that of the first end of the pad leg and the inner diameter of the engaging portion is set smaller than the diameter of the first end of the pad leg.

According to the present invention, since come-off prevention means (recesses, projections, or an uneven portion) is provided on the surface of the engaging portion of the pad leg, wherein when the engaging portion is fitted in the engaging hole at the front portion of the eyeglass frame, the come-off prevention means is brought into engagement with the inner surface of the engaging hole. Accordingly, the pad leg does not come off in use. This allows the function as nose pad to be sufficiently shown.

Since rotation prevention means (a recess, a projection, and or uneven portion) is provide on the surface of the engaging portion of the pad leg, wherein when the engaging portion is fitted in the engaging hole at the front portion of the eyeglass frame, the rotation prevention means is brought into engagement with the inner surface of the engaging hole. Accordingly, the pad leg does not rotate relative to the front portion in use. This allows the function as nose pad to be sufficiently shown.

Since the position of the engaging hole at the front portion of the eyeglass frame and the engaging angle of the pad leg to be fitted in the engaging hole can be adjusted depending on the size, height, etc. of a consumer's nose, the nose pad assembly can provide all consumers with a comfortable feeling to wear.

Furthermore, since the nose pad can be mounted to the pad-mounting portion of the pad leg through the pad-mounting means, the nose pad can easily be mounted.

### BRIEF DESCRIPTION OF THE DRAWINGS

FIG. 1 is a perspective view of a nose pad assembly according to a first embodiment of the present invention;

FIG. 2 is an enlarged partial plan view of the nose pad assembly of FIG. 1;

FIG. 3 is a diagram illustrating a state before the nose pad assembly of FIG. 1 is mounted to the front portion of an eyeglass frame;

FIG. 4 is a diagram illustrating a state after the nose pad assembly of FIG. 1 is mounted to the front portion of the eyeglass frame;

FIG. 5 is an enlarged partial cross-sectional view of the nose pad assembly of FIG. 4;

FIG. 6 is a perspective view of the nose pad of FIGS. 1 and 4;

FIG. 7 is a cross-sectional view of a pad-mounting portion of FIG. 4;

FIG. 8 is a perspective view of a nose pad according to another embodiment of the invention;

FIG. 9 is a perspective view of a nose pad according to yet another embodiment of the invention;

FIG. 10 is a perspective view of a pad-mounting portion according to another embodiment of the invention;

FIG. 11 is a plan view of a nose pad assembly according to a second embodiment of the present invention, showing a pad leg;

FIG. 12 is an enlarged view of the part of FIG. 11;

FIG. 13 is a side view of the part of FIG. 12; and

FIG. 14 is a plan view of a modification of the pad-mounting portion.

### DESCRIPTION OF THE PREFERRED EMBODIMENTS

Embodiments of the present invention will be described hereinafter with reference to the drawings.

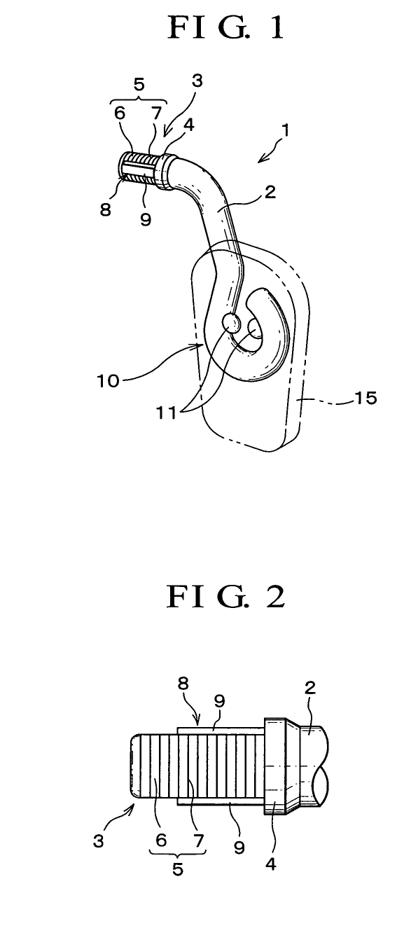

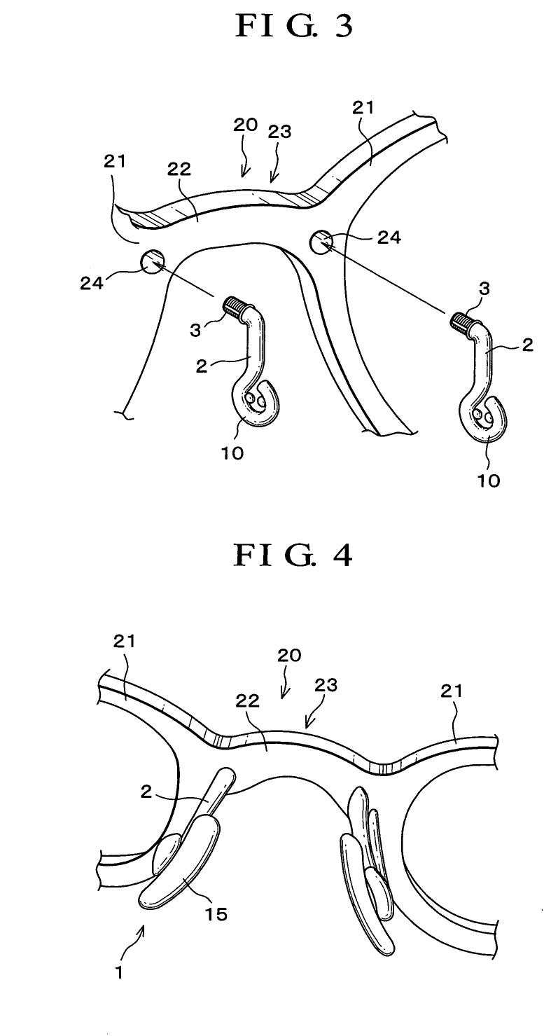

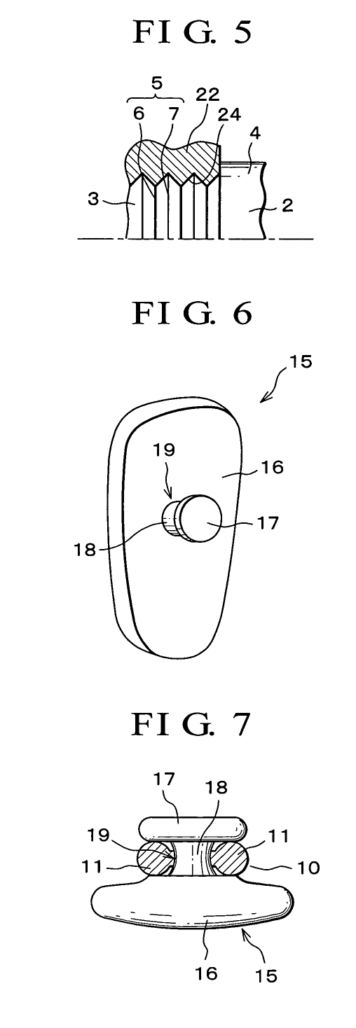

FIGS. 1 to 7 show a nose pad assembly according to a first embodiment of the invention. FIG. 1 is a perspective view of the entire nose pad assembly; FIG. 2 is an enlarged partial plan view of the nose pad assembly of FIG. 1; FIG. 3 is a diagram illustrating a state before the nose pad assembly of FIG. 1 is mounted to the front portion of an eyeglass frame; FIG. 4 is a diagram illustrating a state after the nose pad assembly of FIG. 1 is mounted to the front portion of the eyeglass frame; FIG. 5 is an enlarged partial cross-sectional view of the nose pad assembly of FIG. 4; FIG. 6 is a perspective view of the nose pads of FIG. 1; and FIG. 7 is a cross-sectional view of the pad-mounting portion of FIG. 4.

A nose pad assembly 1 according to the first embodiment includes a pad leg 2 and a nose pad 15 mounted to the pad leg 2. The pad leg 2 is made of a synthetic-resin or metal round rod. One longitudinal end (first end) of the rod is bent at approximately right angle, at which an engaging portion 3 is provided, while the other longitudinal end (second end) is bent in approximately ring shape in a direction opposite to the engaging portion 3, at which a pad-mounting portion 10 is provided. The pad leg 2 is made of a material of higher rigidity (larger) than the front portion 23 of an eyeglass frame 20, described later.

The engaging portion 3 of the pad leg 2 has a stopper 4 extending radially outwards in ring shape integrated with the base thereof. When the engaging portion 3 is fitted in an engaging hole 24 at the front portion 23, described later, the end face of the stopper 4 is brought into contact with the surface of the front portion 23, thereby preventing the engaging portion 3 from further advancing into the engaging hole 24.

Around the engaging portion 3 of the pad leg 2 are integrally provided come-off prevention means 5 and rotation prevention means 8.

As shown in FIGS. 1 and 2, the come-off prevention means 5 is constructed such that a circumferential recess 6 and protrusion 7 are alternately provided along the axis of the engaging portion 3. As shown in FIG. 5, when the engaging portion 3 is fitted in the engaging hole 24 at the front portion 23, the recesses 6 and the protrusions 7 are brought into engagement with the inner surface of the engaging hole 24, thereby preventing the engaging portion 3 from coming off from the engaging hole 24. More specifically, setting the rigidity of the engaging portion 3 of the pad leg 2 higher than that of the front portion 23 that constructs he engaging hole 24 and setting the inner diameter of the engaging hole 24 smaller than the diameter of the engaging portion 3 allows the recess 6 and the protrusion 7 of the engaging portion 3 to be brought into engagement with the inner surface of the engaging hole 24.

The recess 6 and the protrusion 7 are provided around the entire circumference of the engaging portion 3 and perpendicular to the axis of the engaging portion 3. In this embodiment, as shown in FIG. 5, the recess 6 and the protrusion 7 are triangular in cross section, however, may be rectangular or wedge-shaped in cross section. In this embodiment, although the recess 6 and the protrusion 7 are provided around the entire surface of the engaging portion 3, they may be provided only in part of the surface.

As shown in FIGS. 1 and 2, the rotation prevention means 8 is constructed such that an axial protrusion 9 is integrated with the surface of the engaging portion 3. In this embodiment, the protrusion 9 is provided in two positions opposing with the shaft center of the engaging portion 3 as the center. When the engaging portion 3 is fitted in the engaging hole 24 at the front portion 23, the two protrusions 9 are brought into engagement with the inner surface of the engaging hole 24, thereby preventing the engaging portion 3 from rotating relative to the engaging hole 24. More specifically, setting the rigidity of the protrusions 9 of the rotation prevention means 8 higher than that of the front portion 23 which constructs the engaging hole 24 allows the protrusions 9 of the rotation prevention means 8 to be brought into engagement with the inner surface of the engaging holes 24.

The shape of the protrusion 9 is not particularly limited but may be triangular or rectangular in cross section (rectangular in cross section in this embodiment). The protrusion 9 may be provided across the entire length of the engaging portion 3, as in this embodiment, or alternatively, may be provided in part thereof (not shown). Although the protrusion 9 of this embodiment is provided in two positions on the surface of the engaging portion 3, it may be provided at only one position on the engaging portion 3 or at three positions or more.

As shown in FIG. 1, the second end of the pad leg 2 is bent in ring shape in the direction opposite to the engaging portion 3, at which the ring-shaped pad-mounting portion 10 which is open at the top is provided, and a nose pad 15 is mounted to the pad-mounting portion 10 with pad-mounting means 19.

The pad-mounting means 19 includes a groove 18 provided in the nose pad 15, described later. The nose pad 15 is mounted to the pad leg 2 by fitting the pad-mounting portion 10 into the groove 18, thereby mounting the nose pad 15 to the pad leg 2.

The nose pad 15 is made of silicon etc. and includes a pad 16 and a leg 17 integrated with the pad 16, as shown in FIG. 6. The groove 18 of a specified width and depth is provided around the entire circumference of the base of the leg 17 and serves as the pad-mounting means 19.

As shown in FIG. 1, a pair of domical projections 11 projecting inwardly is integrally provided in opposing positions on the inner surface of the pad-mounting portion 10. The projections 11 are brought into pressure contact with the bottom of the groove 18 of the nose pad 15 (refer to FIG. 7) to prevent the nose pad 15 from coming off from the pad-mounting portion 10. It is also possible to provide recesses (not shown) in the positions of the groove 18 which correspond to the projections 11, into which the projections 11 are fitted. It is also possible to provide the pad-mounting portion 10 with a spring force, by which the pad-mounting portion 10 is brought into pressure contact with the bottom of the groove 18.

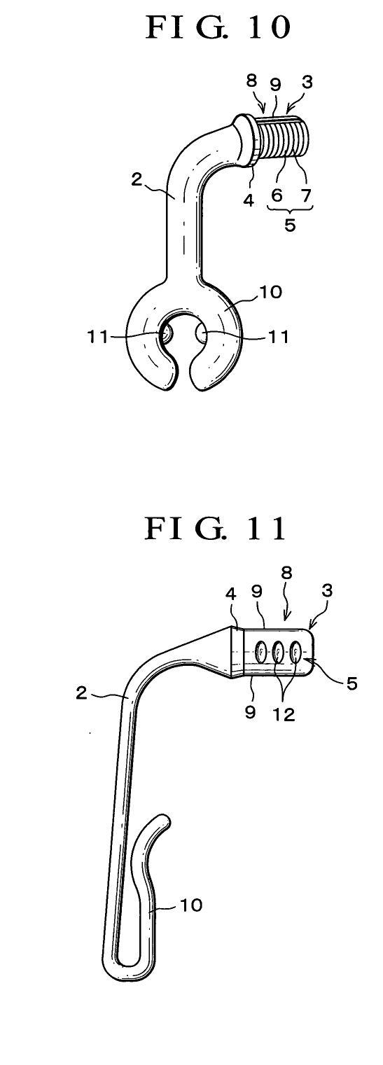

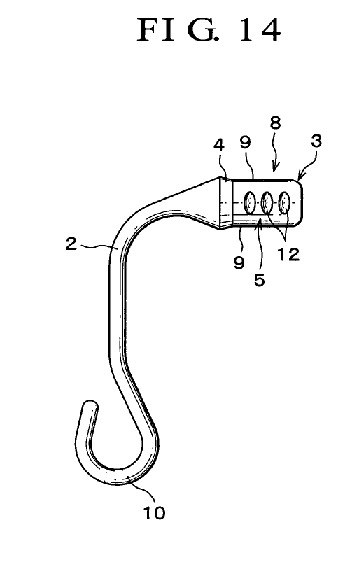

The shape of the pad-mounting portion 10 is not particular limited but may be shaped like a ring that is open at the lower end, as shown in FIG. 10, or may be shaped like a long thin ring having a sprig force, as shown in FIG. 11, or alternatively, may be shaped like a ring having a spring force, as shown in FIG. 14. With the shapes of FIGS. 11 and 14, it makes no difference whether or not the engaging projections are provided.

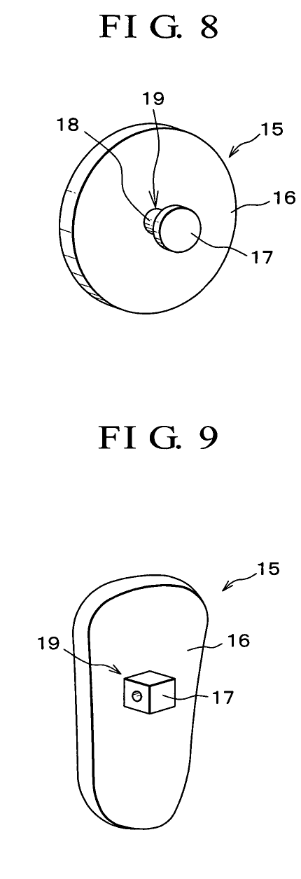

The shape of the nose pad 15 is not particular limited but may have a structure in which the leg 17 is integrated with the circular-disk-shaped pad 16, as shown in FIG. 8, or a structure in which a cored bar is integrated with the substantially elliptical-plate-shaped pad 16, the cored bar projecting from the pad 16 constructs the leg 17, as shown in FIG. 9. Alternatively, other types of nose pads are possible. In the structure shown in FIG. 8, the groove 18 at the base of the leg 17 serves as the pad-mounting means 19; with the structure shown in FIG. 9, the cored bar serves as the pad-mounting means 19.

As shown in FIGS. 3 and 4, the eyeglass frame 20 includes multiple components such as a pair of lens-retaining frames 21, a bridge 22 connecting the inner rims of the lens-retaining frames 21 together, and temples (not shown) closably connected to the outer rims of the lens-retaining frames 21 with hinges (not shown).

The pair of lens-retaining frames 21 and the bridge 22 construct a front portion 23. The rigidity of the front portion 23 is set lower (smaller) than that of the pad leg 2. The bridge 22 of the front portion 23 has engaging holes 24 at the base thereof. The inner diameter of the engaging hole 24 is set smaller than the diameter of the engaging portion 3 of the pad leg 2. The dimensional tolerance between the inner diameter of the engaging hole 24 and the diameter of the engaging portion 3 of the pad leg 2 can be set to an appropriate value in consideration of the material and rigidity of the front portion 23 and the pad leg 2. In this embodiment, the front portion 23 is made of resin but may be made of metal.

When the engaging portion 3 of the pad leg 2 with the above structure is fitted into the engaging hole 24 at the front portion 23 of the eyeglass frame 20, as shown in FIGS. 3 and 4, the recesses 6 and projections 7 of the come-off prevention means 5 at the engaging portion 3 of the pad leg 2 and the projection 9 of the rotation prevention means 8 are brought into engagement with the inner surface of the engaging hole 24 to mount the pad leg 2 to the front portion 23 of the eyeglass frame 20. In this case, the engaging hole 24 may be filled with an adhesive as necessary and then the engaging portion 3 of the pad leg 2 may be fitted in the engaging hole 24. When the engaging portion 3 of the pad leg 2 is fitted into the engaging hole 24 at the front portion 23, it is also possible to heat the periphery of the engaging hole 24 to expand and, in that state, to fit the engaging portion 3 of the pad leg 2 into the engaging hole 24.

In the nose pad assembly 1 with such a structure according to the embodiment, the recesses 6 and projections 7 of the come-off prevention means 5 at the engaging portion 3 of the pad leg 2 and the projection 9 of the rotation prevention means 8 are brought into engagement with the inner surface of the engaging hole 24, so that the nose pad assembly 1 does not come off from the front portion 23 or rotate relative to the front portion 23.

Since the position of the engaging hole 24 at the front portion 23 of the eyeglass frame 20 can be adjusted depending on the size, height, etc. of a consumer's nose, and the engaging portion 3 of the pad leg 2 can be fitted into the engaging hole 24 at a specified angle according to the size, height, etc., the nose pad assembly 1 can provide all consumers with a comfortable feeling to wear.

Although, in this embodiment, the come-off prevention means 5 is constructed of the recesses 6 and the projections 7, the come-off prevention means may be constructed of recesses or projections (not shown).

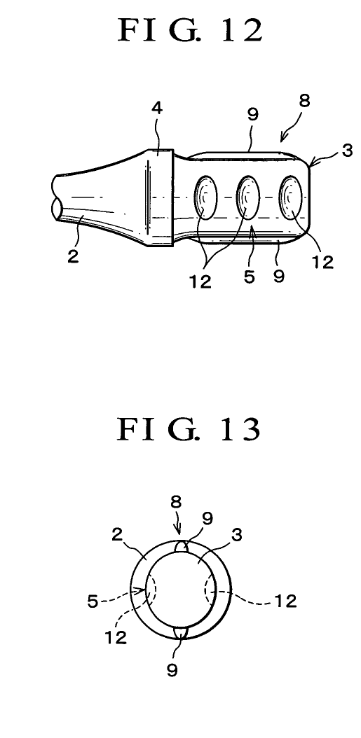

FIGS. 11 to 14 show a nose pad assembly according to a second embodiment of the present invention, in which FIG. 11 is a plan view of the entire pad leg, FIG. 12 is an enlarged view of the part of FIG. 11, FIG. 13 is a side view of the part of FIG. 12, and FIG. 14 is a plan view of a modification of the pad-mounting portion.

The nose pad assembly 1 has recesses 12 on the surface of the engaging portion 3 of the pad leg 2 as the come-off prevention means 5. Since other structures are the same as those of the first embodiment, the same components as those of the first embodiment are given the same numerals and their detailed description will be omitted here.

The recess 12 of the come-off prevention means 5 is shaped like an ellipse which is long along the circumference of the engaging portion 3 and is provided in opposing positions with the axial center of the pad leg 2 as the center, at specified intervals at three locations (six in total) along the axis.

The shape of the recess 12 is not necessarily elliptical but may be in other shapes. Briefly, it has only to be long circumferentially. The recesses 12 may not be provided at six positions but at five positions or less or seven positions or more.

By fitting the engaging portion 3 of the pad leg 2 of the nose pad assembly 1 according to the embodiment into the engaging hole 24 at the front portion 23 of the eyeglass frame 20, as in the first embodiment, the recesses 12 of the come-off prevention means 5 on the surface of the engaging portion 3 and the protrusion 9 of the rotation prevention means 8 are brought into engagement with the inner surface of the engaging hole 24, so that the pad leg 2 is mounted to the front portion 23 of the eyeglass frame 20. In that case, the engaging hole 24 may be filled with an adhesive as necessary and then the engaging portion 3 of the pad leg 2 may be fitted in the engaging hole 24.

Also in the nose pad assembly 1 with such a structure according to the embodiment, the recesses 12 of the come-off prevention means 5 of the engaging portion 3 of the pad leg 2 and the protrusion 9 of the rotation prevention means 8 are in engagement with the inner surface of the engaging hole 24, so that the nose pad assembly 1 does not come off from the front portion 23 or rotate relative to the front portion 23.

Since the position and the engaging angle of the engaging hole 24 at the front portion 23 of the eyeglass frame 20 can be adjusted depending on the size, height, etc. of a consumer's nose, the nose pad assembly 1 can provide all consumers with a comfortable feeling to wear.

Although, in this embodiment, the come-off prevention means 5 is constructed of the elliptical recesses 12 which are long in the circumference direction, the come-off prevention means may be constructed of projections or recesses and projections (not shown), which are long in the circumferential direction.

Although, in this embodiment, the pad-mounting portion 10 is shaped like a long thin ring having a sprig force, by which the leg 17 of the nose pad 15 is retained, the pad-mounting portion 10 may be shaped like a ring, as shown in FIG. 14.

Although, in the foregoing embodiments, the engaging portion 3 of the pad leg 2 is shaped like a round bar, the engaging portion 3 may be shaped like a polygon (rectangle, hexagon, octagon, etc. (not shown)).

1. A nose pad assembly to be mounted to the front portion of an eyeglass frame, comprising:
a pad leg a first end of which is fitted in an engaging hole provided in the front portion; and
a nose pad to be mounted to a second end of the pad leg,
wherein come-off prevention means which can be brought into engagement with the inner surface of the engaging hole is provided on the surface of the first end of the pad leg.

2. A nose pad assembly according to claim 1, wherein the come-off prevention means includes a recess, a projection, or an uneven portion, formed on the surface of the first end of the pad leg.

3. A nose pad assembly according to claim 1, wherein the pad leg includes rotation prevention means which can be brought into engagement with the inner surface of the engaging hole on the surface of the first end of the pad leg.

4. A nose pad assembly according to claim 2, wherein the pad leg includes rotation prevention means which can be brought into engagement with the inner surface of the engaging hole on the surface of the first end of the pad leg.

5. A nose pad assembly according to claim 3, wherein the rotation prevention means includes a recess, a projection, or an uneven portion, formed on the surface of the first end of the pad leg.

6. A nose pad assembly according to claim 4, wherein the rotation prevention means includes a recess, a projection, or an uneven portion, formed on the surface of the first end of the pad leg.

7. A nose pad assembly according to claim 1, wherein the pad leg has a pad-mounting portion at the second end, and wherein the nose pad is mounted to the pad-mounting portion through pad-mounting means.

8. A nose pad assembly according to claim 2, wherein the pad leg has a pad-mounting portion at the second end, and wherein the nose pad is mounted to the pad-mounting portion through pad-mounting means.

9. A nose pad assembly according to claim 3, wherein the pad leg has a pad-mounting portion at the second end, and wherein the nose pad is mounted to the pad-mounting portion through pad-mounting means.

10. A nose pad assembly according to claim 4, wherein the pad leg has a pad-mounting portion at the second end, and wherein the nose pad is mounted to the pad-mounting portion through pad-mounting means.

11. A nose pad assembly according to claim 5, wherein the pad leg has a pad-mounting portion at the second end, and wherein the nose pad is mounted to the pad-mounting portion through pad-mounting means.

12. A nose pad assembly according to claim 6, wherein the pad leg has a pad-mounting portion at the second end, and wherein the nose pad is mounted to the pad-mounting portion through pad-mounting means.
